(19) United States
(12) Patent Application Publication
(10) Pub. No.: US 2021/0406170 A1
(43) Pub. Date: Dec. 30, 2021

(54) Flash-Based Coprocessor

(71) Applicants: MemRay Corporation, Seongnam-si (KR); Korea Advanced Institute of Science and Technology, Daejeon (KR)

(72) Inventors: Myoungsoo JUNG, Daejeon (KR); Jie ZHANG, Daejeon (KR)

(73) Assignees: MemRay Corporation; Korea Advanced Institute of Science and Technology

(21) Appl. No.: 17/304,030

(22) Filed: Jun. 14, 2021

(30) Foreign Application Priority Data
Jun. 24, 2020 (KR) 10-2020-0077018
Dec. 22, 2020 (KR) 10-2020-0180560

(51) Int. Cl. G06F 12/02; G06F 12/1045; G06F 12/0882; G06F 12/0862

(52) U.S. Cl. CPC G06F 12/0246; G06F 12/1054; G06F 2212/7201; G06F 12/0862; G06F 12/0882

(57) ABSTRACT

A processor corresponding to a core of a coprocessor, a cache used as a buffer of the processor, and a flash controller are connected to an interconnect network. The flash controller and a flash memory are connected to a flash network. The flash controller reads or writes target data of a memory request from or to the flash memory.

### CROSS-REFERENCE TO RELATED APPLICATION

This application claims priority to and the benefit of Korean Patent Application No. 10-2020-0077018 filed in the Korean Intellectual Property Office on Jun. 24, 2020, and Korean Patent Application No. 10-2020-0180560 filed in the Korean Intellectual Property Office on Dec. 22, 2020, the entire contents of which are incorporated herein by reference.

### BACKGROUND

### (a) Field

The described technology generally relates to a flash-based coprocessor.

### (b) Description of the Related Art

Over the past few years, graphics processing units (GPUs) has undergone significant performance improvements for a broad range of data processing applications because of the high computing power brought by their massive cores. To reap the benefits from the GPUs, large-scale applications are decomposed into multiple GPU kernels, each contains ten or hundred of thousands of threads. These threads can be simultaneously executed by such GPU cores, which exhibits high thread-level parallelism (TLP). While the massive parallel computing drives the GPUs to exceed CPUs' performance by up to 100 times, the on-board memory capacity of the GPUs is much less than that of the host-side main memory, which cannot accommodate all data sets of the large-scale applications.

To meet the requirement of such large memory capacity, memory virtualization is realized by utilizing a non-volatile memory express (NVMe) solid state drive (SSD) as a swap disk of the GPU memory and leverages a memory management unit (MMU) in the GPU. For example, if a data block requested by a GPU core misses in the GPU memory, the GPU's MMU raises the exception of a page fault. As both the GPU and the NVMe SSD are peripheral devices, the GPU informs the host to service the page fault, which introduces severe data movement overhead. Specifically, the host first needs to load the target page from the NVMe SSD to the host-side main memory and then moves the same data from the memory to the GPU memory. The data copy across different computing domains, the limited performance of the NVMe SSD and bandwidth constraints of various hardware interfaces (e.g., peripheral component interconnect express, PCIe) significantly increase the latency of servicing page faults, which in turn degrades the overall performance of many applications at a user-level.

### SUMMARY

An embodiment provides a flash-based coprocessor for high performance.

According to another embodiment, a coprocessor including a processor, a cache, an interconnect network, a flash network, a flash memory, and a flash controller is provided. The processor corresponds to a core of the coprocessor and generates a memory request. The cache is used as a buffer of the processor. The flash controller is connected to the processor and the cache through the interconnect network, is connected to the flash memory through the flash network, and reads or writes target data from or to the flash memory.

In some embodiment, the flash controller may include a plurality of flash controllers, and memory requests may be interleaved over the flash controllers.

In some embodiment, the coprocessor may further include a memory management unit including a table that stores a plurality of physical addresses mapped to a plurality of addresses respectively and is connected to the interconnect network. Each of the physical addresses may include a physical log block number and a physical data block number. An address of the memory request may be translated into a target physical address that is mapped to the address of the memory request among the physical addresses. The target physical address may include a target physical log block number and a target physical data block number.

In some embodiment, a part of the table may be buffered to a translation lookaside buffer (TLB) of the processor, and the TLB or the memory management unit may translate the address of the memory request into the target physical address.

In some embodiment, the flash memory may include a plurality of physical log blocks, and each of the physical log blocks may store page mapping information between a page index and a physical page number.

In some embodiment, the address of the memory request may split into at least a logical block number and a target page index. When the memory request is a read request and the target page index hits in the page mapping information of a target physical log block indicated by the target physical log block number, the target physical log block may read the target data based on the page mapping information.

In some embodiment, the address of the memory request may be split into at least a logical block number and a target page index. When the memory request is a read request and the target page index does not hit in the page mapping information of a target physical log block indicated by the target physical log block number, a physical data block indicated by the target physical data block number may read the target data based on the target page index.

In some embodiment, the address of the memory request may be split into at least a logical block number and a target page index. When the memory request is a write request, a target physical log block indicated by the target physical log block number may write the target data to a free page in the target physical log block, and store mapping between the target page index and a physical page number of the free page to the page mapping information.

In some embodiment, each of the physical log blocks may include a row decoder, and the row decoder may include a programmable decoder for storing the page mapping information.

According to yet another embodiment, a coprocessor including a processor, a cache, a flash memory, and a flash controller is provided. The processor corresponds to a core of the coprocessor, and the cache is used as a read buffer of the processor. The flash memory includes an internal register used as a write buffer of the processor and a memory space for storing data. When a read request from the processor misses in the cache, the flash controller reads read data of the read request from the flash memory, and first stores write data of a write request from the processor to the write buffer before writing the write data to the memory space of the flash memory.

In some embodiment, the coprocessor may further include an interconnect network that connects the processor, the cache, and the flash controller, and a flash network that connects the flash memory and the flash controller.

In some embodiment, the coprocessor may further include a cache control logic that records an access history of a plurality of read requests, and predicts spatial locality of an access pattern of the read requests to determine a data block to be prefetched.

In some embodiment, the cache control logic may predict the spatial locality based on program counter addresses of the read requests.

In some embodiment, the cache control logic may include a predictor table including a plurality of entries indexed by program counter addresses. Each of the entries may include a plurality of fields that record information on pages accessed by a plurality of warps, respectively, and a counter field that records a counter corresponding to a number of times the pages recorded in the fields are accessed. In a case where a cache miss occurs, when the counter of an entry indexed by a program counter address of a read request corresponding to the cache miss is greater than a threshold, the cache control logic may prefetch a data block corresponding to the page recorded in the entry indexed by the program counter address.

In some embodiment, the counter may increase when an incoming read request accesses a same page as the page recorded in the fields of a corresponding entry, and may decrease when an incoming read request accesses a different page from the page recorded in the fields of the corresponding entry.

In some embodiment, the cache control logic may track data access status in the cache and dynamically adjust a granularity of prefetch based on the data access status.

In some embodiment, the cache may include a tag array, and each of entries in the tag array may include a first bit that is set according to whether a corresponding cache line is filled by prefetch and a second bit that is set according to whether the corresponding cache line is accessed. The cache control logic may increase an evict counter when each cache line is evicted, determine whether to increase an unused counter based on values of the first and second bits corresponding to each cache line, and adjust the granularity of prefetch based on the evict counter and the unused counter.

In some embodiment, when the first bit has a value indicating that the corresponding cache line is filled by prefetch and the second bit has a value indicating that the corresponding cache line is not accessed, the unused counter may be increased. The cache control logic may determine a waste ratio of prefetch based on the unused counter and the evict counter, increase the granularity of prefetch when the waste ratio is higher than a first threshold, and decrease the granularity of prefetch when the waste ratio is lower than a second threshold that is lower than the first threshold.

In some embodiment, the flash memory may include a plurality of flash planes, the internal register may include a plurality of flash registers included in the flash planes, and a flash register group including the flash registers may operate as the write buffer.

In some embodiment, the flash memory may include a plurality of flash planes including a first flash plane and a second flash plane, each of the flash planes may include a plurality of flash registers, and at least one flash register among the flash registers included in each of flash planes may be assigned as a data register. The write data may be stored in a target flash register among the flash registers of the first flash plane. When the write data stored in the target flash register is written to a data block of the second flash plane, the write data may move from the target flash register to the data register of the second flash plane, and may be written from the data register of the second flash plane to the second flash plane.

According to still another embodiment of the present invention, a coprocessor including a processor, a memory management unit, a flash memory, and a flash controller is provided. The processor corresponds to a core of the coprocessor. The memory management unit includes a table that stores a plurality of physical addresses mapped to a plurality of addresses, respectively, and each of the physical addresses includes a physical log block number and a physical data block number. The flash memory includes a plurality of physical log blocks and a plurality of physical data blocks, and each of the physical log blocks stores page mapping information between page indexes and physical page numbers. The flash controller reads data of a read request generated by the processor from the flash memory, based on a physical log block number or target physical data block number that is mapped to an address of the read request among the physical addresses, the page mapping information of a target physical log block indicated by the physical log block number mapped to the address of the read request, and a page index split from the address of the read request.

In some embodiment, the flash controller may write data of a write request generated by the processor to a physical log block indicated by a physical log block number that is mapped to an address of the write request among the physical addresses.

In some embodiment, mapping between a physical page number indicating a page of the physical log block to which the data of the write request is written and a page index split from the address of the write request may be stored in the page mapping information of the physical log block indicated by the physical log block number mapped to the address of the write request.

### BRIEF DESCRIPTION OF THE DRAWINGS

FIG. 1 is an example block diagram of a computing device according to an embodiment.

FIG. 2 and FIG. 3 are drawings for explaining an example of data movement in a GPU according to prior works.

FIG. 4 is a drawing showing an example of a GPU according to an embodiment.

FIG. 5 is a flowchart showing an example of data movement in a GPU according to an embodiment.

FIG. 6 is a drawing showing an example of mapping tables in a GPU according to an embodiment.

FIG. 7 is a drawing showing an example of a flash memory unit in a GPU according to an embodiment.

FIG. 8 is a drawing showing an example of a programmable decoder in a GPU according to an embodiment.

FIG. 9 is a drawing showing an example of a read prefetch module in a GPU according to an embodiment.

FIG. 10 is a drawing showing an example of an operation of a read prefetch module in a GPU according to an embodiment.

FIG. 11, FIG. 12, and FIG. 13 are drawings for explaining examples of a flash register group according to various embodiments.

FIG. 14 is a drawing for explaining an example of a connection structure of a flash register group according to an embodiment.

### DETAILED DESCRIPTION OF THE EMBODIMENTS

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

As used herein, the singular forms “a”, “an” and “the” are intended to include the plural forms as well, unless the context clearly indicates otherwise.

The sequence of operations or steps is not limited to the order presented in the claims or figures unless specifically indicated otherwise. The order of operations or steps may be changed, several operations or steps may be merged, a certain operation or step may be divided, and a specific operation or step may not be performed.

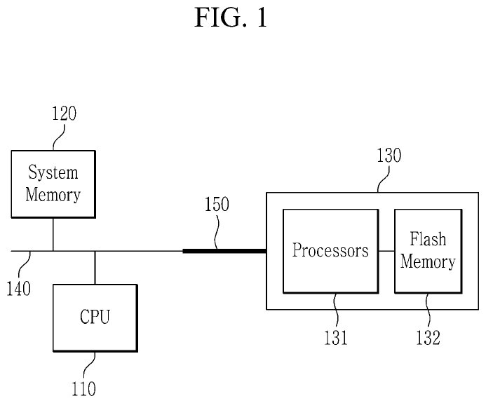

FIG. 1 is an example block diagram of a computing device according to an embodiment. FIG. 1 shows one example of the computing device, and the computing device according to an embodiment may be implemented by various structures.

Referring to FIG. 1, a computing device according to an embodiment includes a central processing unit (CPU) 110, a CPU-side memory (system memory) 120, and a flash-based coprocessor 130. The coprocessor 130 is a supplementary data processing device different from a general-purpose CPU, and may be computer hardware for performing data processing by supplementing functions of the CPU or performing the data processing independently of the CPU. The coprocessor 130 may be a multiprocessors-based coprocessor, and may include, for example, a graphic processing unit (GPU) or an accelerator.

While a conventional coprocessor includes only a plurality of processors for parallelism, the coprocessor 130 according to an embodiment is a flash-based coprocessor, which physically integrates a plurality of processors 131 corresponding to coprocessor cores with a flash memory 132, for example, a solid-state drive (SSD). Accordingly, the coprocessor 130 can self-govern computing operations and data storage using the integrated processors 131 and flash memory 132.

In some embodiments, system including the CPU 100 and the memory 200 may be called a host. The CPU 110 and the system memory 120 may be connected via a system bus, and the coprocessor 130 may be connected to the CPU 110 and the system memory 120 via an interface 150.

In some embodiments, the computing device may offload various applications to the coprocessor 130, which allows the coprocessor 130 to directly execute the applications. In this case, the processors 131 of the coprocessor 130 can directly access the flash memory 132 with executing the application. Therefore, many redundant memory allocations/releases and data copies that are required to read data from an outside memory or write data to the outside memory by the conventional coprocessor can be removed.

Hereinafter, for convenience, a GPU is described as one example of the coprocessor.

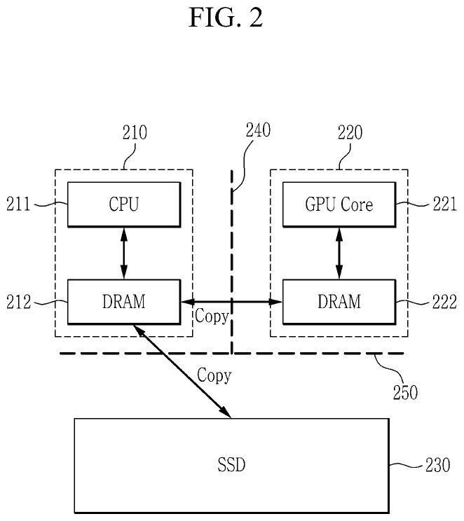

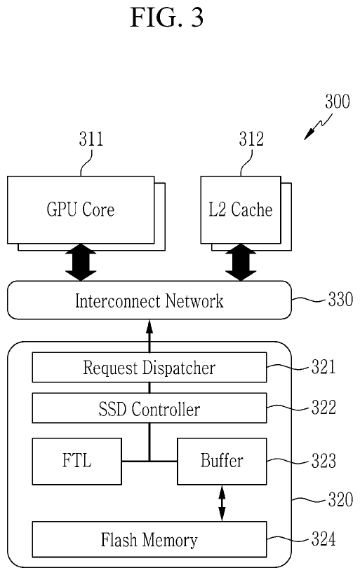

First, prior works for reducing the data movement overhead are described with reference to FIG. 2 and FIG. 3.

FIG. 2 and FIG. 3 are drawings for explaining an example of data movement in a GPU according to prior works.

A system shown in FIG. 2 employs a discrete GPU 220 and SSD 230 as peripheral devices, and connects the GPU 220 and the SSD 230 to a host 210 through PCIe interfaces 240 and 250, respectively. To reduce the data movement overhead, the GPU 220 includes a GPU core 221 and a separate memory, for example, a dynamic random-access memory (DRAM) 222. However, when page faults occur in the GPU 220 due to a limited memory space of the DRAM 222, a CPU 211 serves the page faults by accessing data from the SSD 230 and moving data to the GPU memory 222 through GPU software framework. The page faults require redundant data copies between a DRAM 212 in the host side 210 and the SSD 230 due to the user/privilege mode switches. This wastes cycles of the CPU 211 on the host 210 and reduces data access bandwidth.

To reduce the data movement overhead, as shown in FIG. 3, the inventors have proposed to replace a GPU's on-board DRAM packages with an SSD in a paper “FlashGPU: Placing New Flash Next to GPU Cores” (hereinafter referred to as “FlashGPU”) submitted at the 56th “Annual Design Automation Conference” in 2019. The FlashGPU directly integrates an SSD 320 into a GPU 300 by connecting the SSD 320 to a GPU core 311 through an interconnect network 330, which can eliminate CPU intervention and avoid the redundant data copies. Specifically, the FlashGPU proposes to use Z-NAND™ flash memory as the SSD 320. The Z-NAND, as a new type of NAND flash, achieves 64 times higher capacity than the DRAM, while reducing the access latency of conventional flash memory from hundreds of micro-seconds to a few micro-seconds. However, the Z-NAND faces several challenges to service the GPU memory requests directly: 1) a minimum access granularity of the Z-NAND is a page which is not compatible with a memory request; 2) Z-NAND programming (write) requires an assistance of SSD firmware to manage address mapping as it forbids in-place updates; and 3) its access latency is still much longer than the DRAM. To address these challenges, the FlashGPU employs a customized SSD controller 322 to execute the SSD firmware and has a small DRAM as a read/write buffer 323 to hide the relatively long Z-NAND latency

While the FlashGPU can eliminate the data movement overhead by placing the Z-NAND close to the GPU 300, there is a huge performance disparity when compared with the traditional GPU memory subsystem.

In the FlashGPU, when a request from the GPU core 311 misses in an L2 cache 312, a request dispatcher 321 of the SSD 320 delivers the request to an SSD controller 322. The SSD controller 322 can access a flash memory 324 by translating an address of the request through a flash translation layer (FTL). Therefore, the request dispatcher 321 may be a bottleneck to interact with both the SSD controller 322 and the L2 cache 312.

Further, a maximum bandwidth of the FlashGPU's DRAM buffer 323 may be 96% lower than that of the traditional GPU memory subsystem. This is because the state-of-the-art GPUs employ a plurality of memory controllers (e.g., six memory controllers) to communicate with a dozen of DRAM packages via a 384-bit data bus, while the FlashGPU's DRAM buffer 323 is a single package connected to a 32-bit data bus. Furthermore, an input/output (I/O) bandwidth of flash channels and a data processing bandwidth of the SSD controller 322 may be much lower than those of the traditional GPU memory subsystem. Such bandwidth constrains may also become a performance bottleneck in systems executing applications with large-scale data sets.

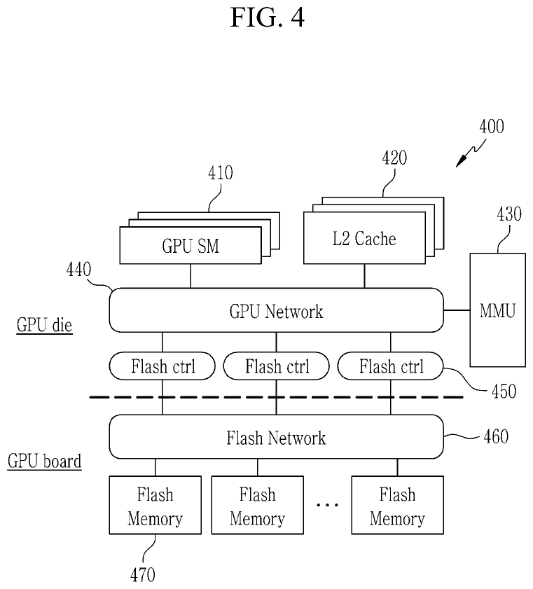

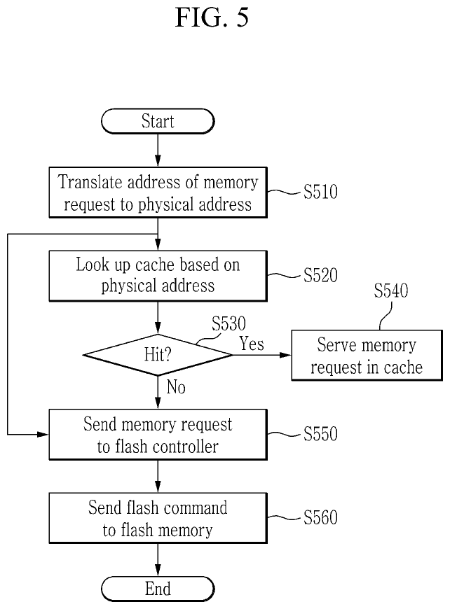

FIG. 4 is a drawing showing an example of a GPU according to an embodiment, and FIG. 5 is a flowchart showing an example of data movement in a GPU according to an embodiment.

Referring to FIG. 4, a GPU 400 includes a plurality of processors 410, a cache 420, a memory management unit (MMU) 430, a GPU interconnect network 440, a plurality of flash controllers 450, a flash network 460, and a flash memory 470.

In some embodiments, the processors 410, the cache 420, the MMU 430, the GPU interconnect network 440, and the flash controllers 450 may be formed on a GPU die, and the flash network 460 and the flash memory 470 may be formed on a GPU board.

Each processor 410 is a GPU processor and corresponds to a core of the GPU 400. The core is a processing unit that reads and executes program instructions. In some embodiments, the processors 410 may be streaming multiprocessors (SMs).

The cache 420 is a cache for the processors 410. In some embodiments, the cache 420 may be an L2 (level 2) cache. In some embodiments, the cache 420 may include a plurality of cache banks.

The MMU 430 is a computer hardware unit that performs translation of virtual memory addresses to physical addresses.

The GPU interconnect network 440 connects the processors 410 corresponding to the cores to other nodes, i.e., the cache 420 and the MMU 430. In addition, the GPU interconnect network 440 connects the processors 410, the cache 420 and the MMU 430 to the flash controllers 450. In some embodiments, the flash controller 450 may be directly connected to the GPU interconnect network 440.

The flash network 460 connects the flash controllers 450 to the flash memory 470. In other words, the flash controllers 450 are connected to the flash memory 470 through the flash network 460. Further, the flash network 460 is directly attached to the GPU interconnect network 440 through the flash controllers 450. As such, the flash memory 470 may be not directly connected to the GPU interconnect network 440, and may be connected to the flash controllers 450 connected to the GPU interconnect network 440 through the flash network 460. The flash controllers 450 manage I/O transactions of the flash memory 470. The flash controllers 450 interact with the GPU interconnect network 400 to send/receive request data to/from the processors 410 and the cache 420. In some embodiments, memory requests transferred from the processors 410 or the cache 420 may be interleaved over the flash controller 450.

In some embodiments, the flash memory 470 may include a plurality of flash memories, for example, a plurality of flash packages (or chips). In some embodiments, the flash package may be an NAND package. In one embodiment, the flash package may be a Z-NAND™ package. In some embodiments, the flash controller 450 may read target data of a memory request (I/O request) from the flash memory 470 or write target data of the memory request to the flash memory 470. In some embodiments, the flash memory 470 may include internal registers and a memory space.

Frequency and hardware (electrical lane) configurations of the flash memory 470 for I/O communication may be different from those of the GPU interconnect network 440. For example, the flash memory 470 may use an open NAND flash interface (OFI) for the I/O communication. In addition, since a bandwidth capacity of the GPU interconnect network 440 much exceeds total bandwidth brought by all the flash packages 470, directly attaching the flash packages 470 to the GPU interconnect network 440 can significantly underutilize the network resources. Accordingly, the flash memory 470 is connected to the flash network 460 instead of the GPU interconnect network 440. In some embodiments, a mesh structure may be employed as the flash network 460, which can meet the bandwidth requirement of the flash memory 470 by increasing the frequency and link widths.

In some embodiments, the GPU 400 may assign the cache 420 as a read buffer and assign internal registers of the flash memory 470 as a write buffer. In one embodiment, assigning the cache 420 and the internal registers as the buffers can remove an internal data buffer of the traditional GPU. In some embodiments, the cache 420 may include a resistance-based memory to buffer more number of pages from the flash memory 470. In one embodiment, the cache 420 may include a magnetoresistive random-access memory (MRAM) as the resistance-based memory. In one embodiment, the cache 420 may include a spin-transfer torque MRAM (STT-MRAM) as the MRAM. Accordingly, a capacity of the cache 420 can be increased. However, as the MRAM suffers from long write latency, it is difficult to respond to write requests. Thus, the internal registers of the flash memory 470 may be assigned as the write buffer.

In some embodiments, as shown in FIG. 4, compared with the FlashGPU shown in FIG. 3, the request dispatcher, the SSD controller, and the data buffer which are placed between the cache 420 and the flash memory 470 may be removed.

In some embodiments, as the SSD controller is removed, an FTL may be offloaded to other hardware components. Generally, an MMU is used to translate virtual addresses of memory requests to memory addresses. Accordingly, the FTL may be implemented on the MMU 430. Accordingly, the MMU 430 may directly translate a virtual address of each memory to a flash physical address. In this case, a zero-overhead FTL can be achieved. However, MMU 430 may not have a sufficient space to accommodate all mapping information of the FTL.

In some embodiments, an internal row decoder of the flash memory 470 may be revised to remap the address of the memory request to a wordline of a flash cell array included in the flash memory 470. In this case, while the FTL overhead can be eliminated, reading a page requires searching the row decoders of all planes of the flash memory 470, which may introduce huge access overhead.

In some embodiments, the above-described two approaches may be collaborated. In general, since a wide spectrum of the data analysis workloads is read-intensive, they may generate only a few write requests to the flash memory 470. Accordingly, a mapping table of the FTL may be split into a read-only block mapping table and a log page mapping table. In some embodiments, to reduce a size of the mapping table, the block mapping table may record mapping information of a flash block (e.g., a physical log block, a physical data block) rather than a page. This design may in turn reduce the size of the block mapping table (e.g., to 80 KB), which can be placed in the MMU 430. While a read request may leverage the read-only block mapping table to find out its flash physical address, the block mapping table may not remap incoming write requests to the flash pages. Accordingly, in some embodiments, the log page mapping table may be implemented in the flash row decoder. The MMU 430 may calculate the flash block addresses of the write requests based on the block mapping table. Then, the MMU 430 may forward the write requests to a target flash block. The row decoder of the target flash block may remap the write requests to a new page location in the flash block (e.g., the physical log block). In some embodiments, once the spaces of the physical log blocks in the flash memory 470 are used up, a GPU helper thread may be allocated to reclaim the flash blocks by performing garbage collection.

Referring to FIG. 4 and FIG. 5, when the processor 410 generates a memory request, a translation lookaside buffer (TLB) of the processor 410 or the MMU 430 translates a logical address of the memory request to a flash physical address at operation S510. Since the cache 420 is indexed by flash physical address, the processor 410 looks up the cache 420 based on the translated physical address at operation S520. In some embodiments, the processor 410 may look up the cache 420 when the memory request is a read request. When the memory request hits in the cache 420 at operation S530, the processor 410 serves the memory request in the cache 420 at operation S540.

When the memory request misses in the cache 420 at operation S530, the cache 420 sends the memory request to one of the flash controllers 450 at operation S550. In some embodiments, when the memory request is a write request, the processor 410 may forward the memory request to one of the flash controllers 450 without looking up the cache 420. The flash controller 450 decodes the physical address of the memory request to find a target flash memory (e.g., a target flash plane) and converts the memory request into a flash command to send it to the target flash memory at operation S560. The target flash memory may read or write data by activating a word line corresponding to the decoded physical address. In some embodiments, the flash controller 450 may first store the target data to a flash register before writing the target data to the target flash memory.

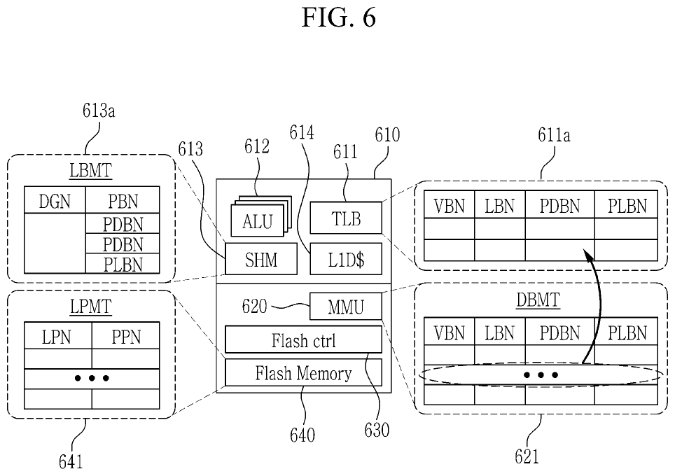

Next, embodiments for implementing the FTL are described with reference to FIG. 6 to FIG. 8.

FIG. 6 is a drawing showing an example of mapping tables in a GPU according to an embodiment.

Referring to FIG. 6, an MMU 620 includes a data block mapping table (DBMT) 621. In some embodiments, the DBMT 621 may be implemented as a two-level page table. The DBMT 621 has a plurality of entries. Each entry may store a virtual block number (VBN), and a physical log block number (PLBN) and a physical data block number (PDBN) corresponding to the VBN. As such, the DBMT 621 may store a mapping among the VBN, the PLBN and the PDBN. In some embodiments, each entry of the DBMT 621 may further store a logical block number (LBN) corresponding to the VBN. The VBN may indicate a data block address of a user application in a virtual address space, and may correspond to a virtual address input to the MMU 620. The PLBN and the PDBN may indicate a flash address of a flash memory. That is, the PLBN may indicate a corresponding a physical log block, and the PDBN may indicate a corresponding physical data block. The LBN may indicate a global memory address. In some embodiments, the virtual address may be split into at least the LBN and a page index. In one embodiment, the virtual address may be split into at least the LBN, the page index, and a page offset.

The physical data block of the flash memory 640 may sequentially store the read-only flash pages. When a memory request accesses read-only data, the memory request may locate a position of target data from the PDBN by referring to a virtual address (which may be called a “logical address”) of the memory request, for example, a VBN of the virtual address as an index. On the other hand, a write request may be served by the physical log block. In some embodiments, a logical page mapping table (LPMT) 641 may be provided for each physical log block of the flash memory 640. Each LPMT 641 may be stored in a row decoder of a corresponding physical log block. Each entry of the LPMT 641 may store a physical page number (PPN) in a corresponding physical log block and a page index (which may be called a “logical page number (LPN)”) corresponding to the PPN. As such, the LPMT 641 may store page mapping information between the page index in the physical log block and the physical page number. When a memory request accesses a modified physical data block through a physical log block, the memory request may refer to the LPMT 641 to find out a physical location of target data.

In some embodiments, a processor 610 may further include a translation lookaside buffer (TLB) 611 to accelerate the address translation. The TLB 611 may buffer entries 611a of the DBMT 621, which are frequently inquired by GPU kernels.

In some embodiments, the processor 610 may include arithmetic logic units (ALUs) 612 for executing a group of a plurality threads, called warp, and an on-chip memory. The on-chip memory may include a shared memory (SHM) 613 and an L1 cache (e.g., an L1 data (L1D) cache) 614. On the other hand, the physical log blocks may come from an over-provisioned space of the flash memory 640. In some embodiments, considering the limited over-provisioned space of the flash memory 640, a group of a plurality of physical data blocks may share a physical log block. Accordingly, a log block mapping table (LBMT) 613a may store mapping information between the physical log block and the group of physical data blocks. Each entry of the LBMT 613a may have a data group number (DGN) and a physical block number (PBN). PDBNs of the physical data blocks and a PLBN of the physical log block shared by the physical data blocks may be stored in the physical block number. In some embodiments, the on-chip memory, for example the shared memory 613 may store the LBMT 613a.

While the MMU 620 may perform the address translation, the MMU 620 may not support other functionalities of the FTL, such as wear-levelling algorithm and garbage collection. In some embodiments, the wear-levelling algorithm and the garbage collection may be implemented in a GPU helper thread. When all flash pages in a physical log block have been used up, the GPU helper thread may perform the garbage collection, thereby merging pages of physical data blocks and physical log blocks. Then, the GPU helper thread may select empty physical data blocks based on the wear-levelling algorithm to store the merged pages. Lastly, the GPU helper thread may update corresponding information in the LBMT 613a and the DBMT 621.

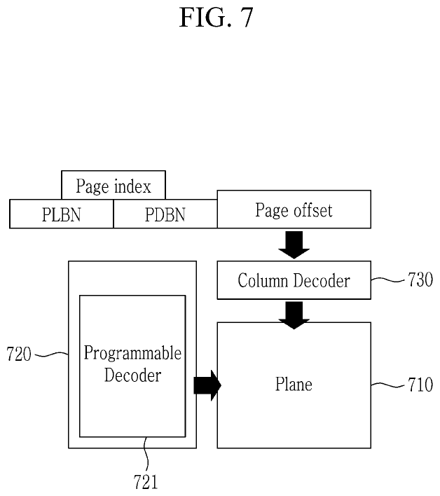

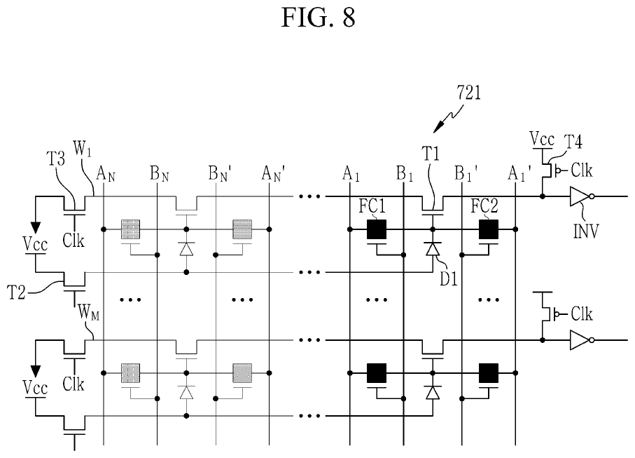

Next, embodiments for implementing an LPMT in a flash memory are described with reference to FIG. 7 and FIG. 8.

FIG. 7 is a drawing showing an example of a flash memory unit in a GPU according to an embodiment, and FIG. 8 is a drawing showing an example of a programmable decoder in a GPU according to an embodiment.

Referring to FIG. 7, a predetermined unit of a flash memory includes a flash cell array 710, a row decoder 720, and a column decoder 730. In some embodiments, the predetermined unit may be a plane.

The flash cell array 710 includes a plurality of word lines (not shown) extending substantially in a row direction, a plurality of bit lines (not shown) extending substantially in a column direction, and a plurality of flash memory cells (not shown) that are connected to the word lines and the bit lines and are formed in a substantially matrix format.

To access a page corresponding to target data of a memory request, the row decoder 720 activates corresponding word lines among the plurality of word lines. In some embodiments, the row decoder 720 may activate the corresponding word lines among the plurality of rows based on a physical page number.

To access the page corresponding to the target data of the memory request, the column decoder 730 activates corresponding bit lines among the plurality of bit lines. In some embodiments, the column decoder 730 may activate corresponding bit lines among the plurality of bit lines based on a page offset.

As described above, an MMU (e.g., 620 of FIG. 6) may translate a virtual address (logical address) of the memory request to a physical address (e.g., a PLBN and a PDBN), and forward the translated physical address to a corresponding flash controller (e.g., 630 of FIG. 6) based on a DBMT (e.g., 621 of FIG. 6). The flash controller 630 may decode the physical address of each memory request and convert the memory request into a flash command. The decoded physical address may include the PLBN, the PDBN, and a page index. In some embodiments, the page index may be generated based on a remainder after a logical page address of the memory request is divided by a block size. The flash controller 630 may find out target flash media (e.g., a target flash plane of a target flash die) based on the physical address, and a flash command (a read command or a write command) to the target flash media (e.g., the row decoder 720 of the target flash media). The decoded physical address may further include a page offset, and the page offset may be sent to a column decoder 730 of the target flash media.

To serve a read request, for target data of the read request (memory request), a control logic of the target flash media may look up an LPMT corresponding to a target PLBN of the read request (i.e., an LPMT of a target physical log block indicated by the target PLBN). In some embodiments, the control logic of the target flash media may look up a programmable decoder 721 of the target physical log block by referring to a target page index split from a virtual address of the read request. When the read request hits in the LPMT, the row decoder 720 may read the target data by activating a corresponding word line (i.e., row) in the target physical log block based on page mapping information of the LPMT. In some embodiments, when the target page index is stored in the LPMT, the read request may hit in the LPMT. In some embodiments, the row decoder 720 may look up a physical page number mapped to the target page index based on the page mapping information of the LPMT, and read the target data by activating the word line corresponding to the physical page number in the target physical log block.

When the read request does not hit in the LPMT (i.e., when the target page index split from the read request is not stored in the LPMT), the row decoder 720 may activate a word line (i.e., row) based on the target page index and a target PDBN of the read request. In some embodiments, the row decoder 720 may read the target data by activating the word line corresponding to the target page index among a plurality of word lines in a target physical data block indicated by the target PDBN of the read request.

To serve a write request, the control logic may select a free page in a target physical log block indicated by the target PLBN and write (program) target data of the write request through the row decoder 720. As the target data is programmed to the free page in the target physical log block, new mapping information corresponding to the free page may be recorded to the LPMT of the target physical log block. In some embodiments, mapping information between a target page index split from the write request and a physical page number to which the target data is programmed may be recorded to the LPMT of the target physical log block. In some embodiments, when an in-order programming is used, a next available free page number in the physical log block may be tracked by using a register.

Referring to FIG. 8, the programmable decoder 721 of the row decoder 720 may include word lines W₁-W_{M} as many as those of the physical log block of the flash cell array 710. Each word line Wⱼ of the programmable decoder 721 may be connected to 2N flash cells FC1 and FC2, and 4N bit lines A₁-A_{N}, B₁-B_{N}, and B₁′-B_{N}′. Here, N may be a physical address length. In some embodiments, M may be equal to 2^{N}. The page mapping information of the LPMT may be programmed in the flash cells of the programming decoder 721 by activating corresponding word lines and bit lines.

Four bit lines Aᵢ, Bᵢ, Aᵢ′, and Bᵢ′, and one word line Wⱼ may form one memory unit. In this case, a transistor T1 may be formed on the word line Wⱼ for each memory unit in order to control voltage transfer through the word line In other words, the word line Wⱼ may be connected through a source and drain of the transistor T1. One memory unit may include two flash cells FC1 and FC2. In the flash cell FC1, one terminal (e.g., source) may be connected to the bit line Aᵢ, the other terminal (e.g., drain) may be connected to a gate of the transistor T1, and a floating gate may be connected to the bit line Bᵢ. In another flash cell FC2, one terminal (e.g., source) may be connected to the bit line Aᵢ′, the other terminal (e.g., drain) may be connected to the gate of transistor T1, and a floating gate may be connected to the bit line Bᵢ′. In addition, a cathode of a diode D1 may be connected to the gate of the transistor T1, and an anode of the diode D1 may be connected to a power supply that supplies a high voltage (e.g., Vcc) through a protection transistor T2. The diodes D1 of all memory units in one word line Wⱼ may be connected to the same protection transistor T2. A protection control signal may be applied to a gate of the protection transistor T2.

One terminal of each word line Wⱼ may be connected to a power supply (e.g., a ground terminal) that supplies a low voltage (GND) through a transistor T3, and the other terminal of each word line Wⱼ may be connected to the power supply supplying the high voltage Vcc through a transistor T4. In addition, the other terminal of each word line Wⱼ may be connected to a corresponding word line of the flash cell array. In some embodiments, the other terminal of each word line Wⱼ may be connected to a corresponding word line of the flash cell array through an inverter INV. The transistors T3 and T4 may operate in response to a clock signal Clk. When the transistor T3 is turned on, the transistor T4 may be turned off. When the transistor T3 is turned off, the transistor T4 may be turned on. To this end, the two transistors T3 and T4 are formed with different channels, and the clock signal Clk may be applied to gates of the transistors T3 and T4.

First, a write (programming) operation in the programmable decoder 721 is described. In some embodiments, the programmable decoder 721 may activate a word line corresponding to a free page of a physical log block. In this case, the protection transistor T2 connected to the activated word line Wⱼ may be turned off so that drains of the flash cells FC1 and FC2 of each memory unit connected to the activated word line Wⱼ may be floated. Further, the protection transistor T2 connected to the deactivated word line may be turned on so that the high voltage Vcc may be applied to the drains of the flash cells FC1 and FC2 of each memory unit connected to the deactivated word line.

Furthermore, each bit of a page index may be converted to a high voltage or a low voltage, the converted voltage may be applied to the bit lines B₁-B_{N}, and an inverse voltage of the converted voltage may be applied to the bit lines B₀′-B_{N}′. For example, a value of ‘1’ in each bit may be converted to the high voltage (e.g., Vcc), and a value of ‘0’ may be converted to the low voltage (e.g., GND). In addition, the high voltage (e.g., Vcc) may be applied to other bit lines A₁-A_{N} and A₁′-A_{N}′. In this case, in the activated word line Wⱼ, the flash cells connected to the bit lines to which the high voltage Vcc is applied among the bit lines B₁-B_{N} and B₁′-B_{N}′ may be programmed, and the flash cells connected to the bit lines to which the low voltage GND is applied among the bit lines B₁-B_{N} and B₁′-B_{N}′ may not be programmed. Further, the flash cells connected to the deactivated word line may not be programmed due to the high voltage Vcc applied to the sources and drains.

Accordingly, a value corresponding to the page index may be programmed in the activated word line (i.e., a row (word line) corresponding to the physical page number of the physical log block). The programmable decoder 721 may operate as a content addressable memory (CAM).

Next, a read (search) operation in the programmable decoder 721 is described. In the read operation, the protection transistors T2 of all word lines W₁-W_{M} may be turned off. In the first phase, in response to the clock signal Clk (e.g., the clock signal Clk having a low voltage), the transistor T3 may be turned off and the transistor T4 may be turned on. In addition, the low voltage may be applied to the bit lines B₁-B_{N} and B₁′-B_{N}′ so that the transistors T1 connected to the word line W₁-W_{M} may be turned off. Then, the word lines W₁-W_{M} may be charged with the high voltage Vcc through the turned-on transistors T4. In the second phase, the clock signal Clk may be inverted so that the transistor T3 may be turned on and the transistor T4 may be turned off. In addition, the voltages converted from the page index to be searched and their inverse voltages may be applied to the bit lines A₁-A_{N} and A₁′-A_{N}′. When the page index matches the value stored in any word line, the transistor T1 may be turned on by the high voltage among the high and low voltages applied to the two bit lines in each of the memory units of the corresponding word line. Accordingly, the low voltage GND may be transferred to the inverter INV through the corresponding word line through the transistor T3 turned on by the clock signal Clk, and a corresponding word line (i.e., row) of the physical log block may be activated by the inverter INV.

Accordingly, the row of the physical log block corresponding to the page index (i.e., the physical page number of the physical log block) can be detected.

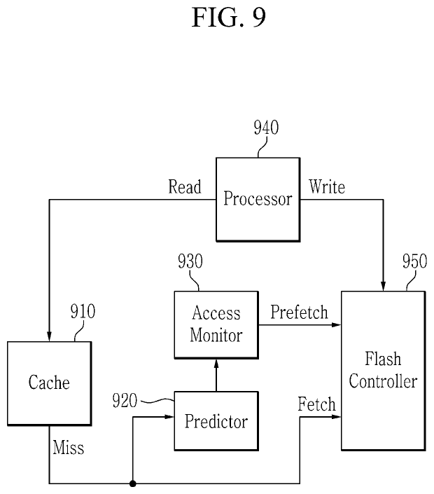

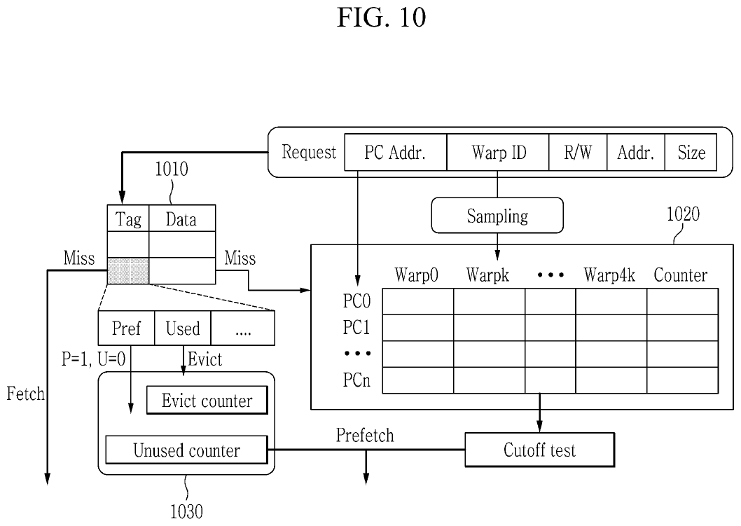

Next, a read optimization method in a GPU according to embodiments is described with reference to FIG. 9 and FIG. 10.

FIG. 9 is a drawing showing an example of a read prefetch module in a GPU according to an embodiment, and FIG. 10 is a drawing showing an example of an operation of a read prefetch module in a GPU according to an embodiment.

Referring to FIG. 9, when a memory request generated by a processor 940 is a read request, the memory request may be looked up in a cache 910 operating as a read buffer. When the memory request is a write request, the memory request may be transferred to a flash controller 950.

A GPU may further include a predictor to prefetch data to the cache 910. Once memory requests miss in the cache 910, the memory requests may be forwarded to the predictor 920. The missed memory requests may be forwarded to the flash controllers 950 and fetch target data from a flash memory through the flash controllers 950.

If the cache 910 can accurately prefetch target data blocks from the flash memory, the cache 910 can better serve the memory requests. Accordingly, in some embodiments, the predictor 920 may speculate spatial locality of an access pattern, generated by user applications, based on the incoming memory requests. If the user applications access continuous data blocks, the predictor 920 may inform the cache 910 to prefetch the data blocks. In some embodiments, the predictor 920 may perform a cutoff test by referring to program counter (PC) addresses of the memory requests. In this case, when a counter of a corresponding PC address is greater than a threshold (e.g., 12), the predictor 920 may inform the cache 910 to execute the read prefetch. In some embodiments, a data block corresponding to a page recorded in an entry indexed by the PC address whose counter is greater than the threshold may be prefetched.

As the limited size of the cache 910 cannot accommodate all prefetched data blocks, the GPU may further include an access monitor 930 to dynamically adjust a data size (a granularity of data prefetch) in each prefetch operation. In some embodiments, when the predictor 920 determines prefetching the data blocks, the access monitor 930 may dynamically adjust the prefetch granularity based on a status of data accesses.

In some embodiments, the cache 910 may include an L2 cache of the GPU. In some embodiments, the predictor 920 and the access monitor 930 may be implemented in a control logic of the cache 910. In some embodiments, the cache 910, the predictor 920, and the access monitor 930 may be referred to as a read prefetch module.

In some embodiments, as shown in FIG. 10, a predictor 1020 may record an access history of read requests and speculate a memory access pattern based on a PC address of each thread. The memory request may include a PC address, a warp identifier (ID), a read/write indicator, an address, and a size. Since memory requests generated from load/store (LD/ST) instructions of the same PC address may exhibit the same access patterns, the memory access pattern may be predicted based on the PC address of each thread. The predictor 1020 may include a predictor table, and the predictor table may have a plurality of entries indexed by PC addresses. Each entry may include a plurality of fields for different warps to store logical page numbers that the warps are accessing, and track the accesses of the warps. The plurality of fields may be distinguished by warp IDs. In some embodiments, a plurality of representative warps, for example, five representative warps (Warp0, Warpk, Warp2k, Warp3k, and Warp4k) may be sampled and be used in the predictor table. Each entry may further include a counter to store the number of re-accesses to the recorded pages. For example, if the warp (Warp0) generates a memory request based on PC address 0 (PC0) and the memory request targets to the same page as the page (i.e., the page number) recorded in the predictor table, the counter may be changed (e.g., may increase by one). If the memory request accesses a page different from the page (page number) recorded in the predictor table, the counter may be changed (e.g., may decrease by one), and a new page number (i.e., a number of the page accessed by the memory request) may be filled in the corresponding field (e.g., the field corresponding to Warp0 of PC0) of the predictor table.

When there is a cache miss of the memory request in the cache 1010, a cutoff test of read prefetch may check the predictor table by referring to the PC address of the memory request. When a counter value of the corresponding PC address is greater than a threshold (e.g., 12), the predictor 1020 may inform the cache 1010 to perform the read prefetch. In some embodiments, data blocks corresponding to the pages recorded in the entry indexed by the corresponding PC address may be prefetched.

In some embodiments, the cache 1010 may include a tag array, and each entry of the tag array may be extended with fields of accessed bit (Used) and a prefetch bit (Pref). These two fields may be used to check whether the prefetched data have been early evicted due to a limited space of a cache 1010. Specifically, the prefetch bit Pref may be used to identify whether a corresponding cache line is filled by prefetch, and the accessed bit Used may be record whether a corresponding cache line has been accessed by a warp. When the cache line is evicted, the prefetch bit Pref and the accessed bit Used may be checked. In some embodiments, the prefetch bit Pref may be set to a predetermined value (e.g., ‘1’) when the corresponding cache line is filled by the prefetch, and the accessed bit Used may be set to a predetermined value (e.g., ‘1’) when the corresponding cache line is accessed by the warp. When the cache line is filled by the prefetch but has not been accessed by the warp, this may indicate that a read prefetch may introduce cache thrashing. As such, the access status of the prefetched data can be tracked through extension of the tag array.

In some embodiments, to avoid early eviction of the prefetched data and improve the utilization of the cache 1020, an access monitor 1030 may dynamically adjust the granularity of data prefetch. When a cache line is evicted, the access monitor 1030 may update (e.g., increase) an evict counter and an unused counter by referring to the prefetch bit Pref and the accessed bit Used. In some embodiments, the evict counter may increase by one when the cache line is evicted, and the unused counter may increase by one when the prefetch bit Pref has a value (e.g., ‘1’) indicating that a corresponding cache line is filled and the accessed bit Used have a value (e.g., ‘0’) indicating that the corresponding cache line has not been accessed.

The access monitor 1030 may calculate a waste ratio of the data prefetch based on the evict counter and the unused counter. In some embodiments, the access monitor 1030 may calculate the waste ratio of the data prefetch by dividing the unused counter with the evict counter. To this end, the access monitor 1030 may use a high threshold and a low threshold. When the waste ratio is higher than the high threshold, the access monitor 1030 may decrease the access granularity of data prefetch. In some embodiments, when the waste ratio is higher than the high threshold, the access monitor 1030 may decrease the access granularity by half. When the waste ratio is lower than the low threshold, the access monitor 1030 may increase the access granularity. In some embodiments, when the waste ratio is lower than the low threshold, the access monitor 1030 may increase the access granularity by 1 KB. As such, the granularity of data prefetch can be dynamically adjusted by adjusting the access granularity by comparing the waste ratio indicating a ratio in which the cache 1010 is wasted with the thresholds.

In some embodiments, to determine the optimal thresholds, an evaluation may be performed by sweeping different values of the high and low thresholds. In some embodiments, the best performance may be achieved by configuring the high and low thresholds as 0.3 and 0.05, respectively. Such the high and low thresholds may be set by default.

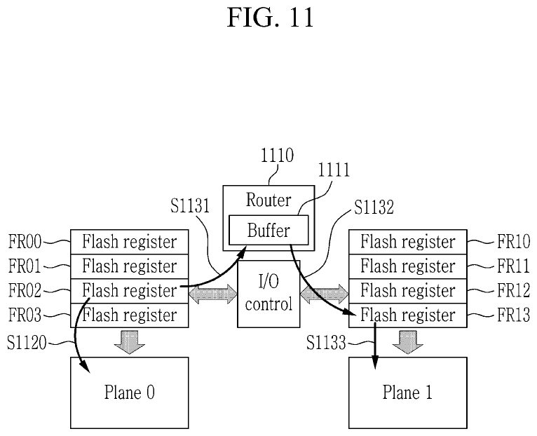

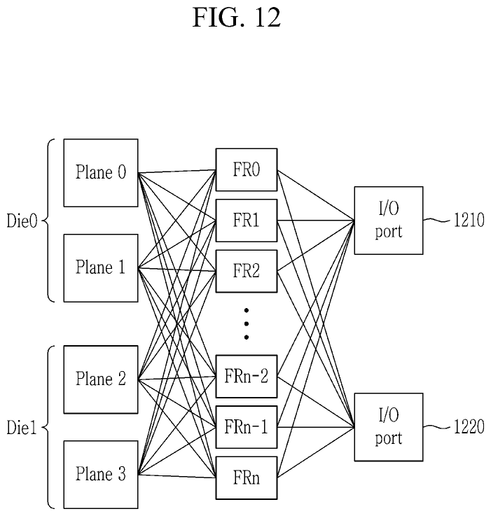

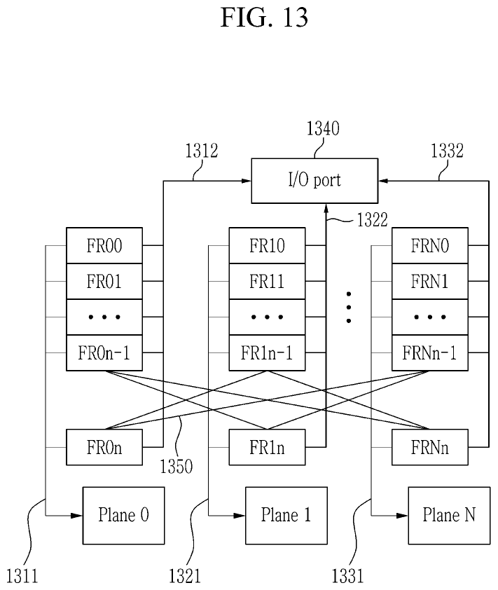

Next, a write optimization method in a GPU according to embodiments is described with reference to FIG. 11 to FIG. 14.

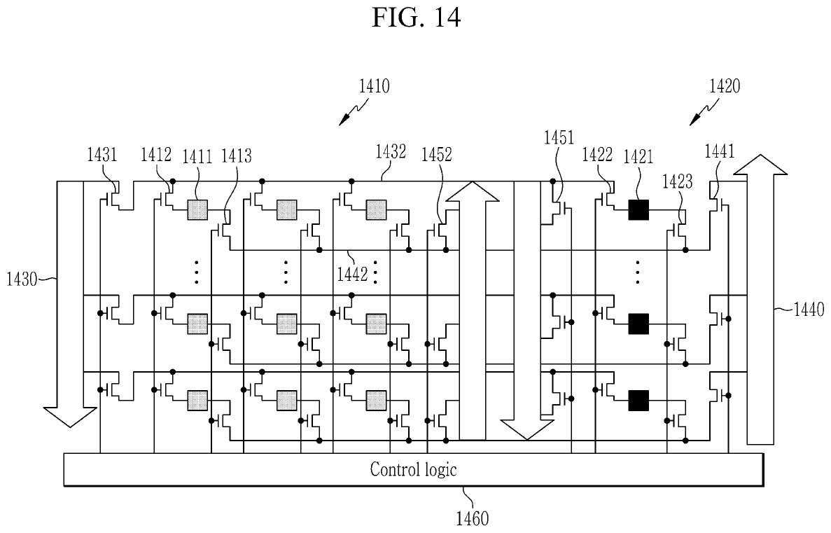

FIG. 11, FIG. 12, and FIG. 13 are drawings for explaining examples of a flash register group according to various embodiments, and FIG. 14 is a drawing for explaining an example of a connection structure of a flash register group according to an embodiment.

In some embodiments, internal registers (flash registers) of a flash memory may be assigned as a write buffer of a GPU. In this case, a memory space excluding the internal registers from the flash memory may be used to finally store data.

In general, an SSD may redirect requests of different applications to access different flash planes, which can help reduce write amplification. In addition, the application may exhibit asymmetric accesses to different pages. Due to asymmetric writes on flash planes, a few flash registers may stay in idle while other flash registers may suffer from a data thrashing issue. Hereinafter, embodiments for addressing these issues are described.

Referring to FIG. 11, a plurality of flash registers are grouped. Accordingly, write requests may be served so that data can be placed in anywhere of the flash registers.

In some embodiments, a plurality of flash registers included in the same flash package may be grouped into one group. In one embodiment, the plurality of flash registers included in the same flash package may be all flash registers included in the flash package. For convenience, it is shown in FIG. 11 that two flash planes (Plane0 and Plane1) are included in one flash package, and four flash registers (FR00, FR01, FR02, FR03 or FR10, FR11, FR12, FR13) are formed in each flash plane (Plane0 or Plane1). In this case, the flash registers (FR00, FR01, FR02, FR03, FR10, FR11, FR12, and FR13) of the flash planes (Plane0 and Plane1) may form a flash register group. The flash register group may operate as a cache (buffer) for write requests. In some embodiments, the flash register group may operate as a fully-associative cache. Accordingly, a flash controller may store target data of a write request in a certain flash register of the flash register group operating as the cache.

The flash controller may directly control the flash register (e.g., FR02) to write the target data stored in the flash register FR02 to a local flash plane (e.g., Plane0), i.e., a log block or data block of the local flash plane (Plane0) at operation S1120. The local flash plane may be the same flash plane as the flash register in which the target data is stored.

Alternatively, the flash controller may write the target data stored in the flash register FR02 to a remote flash plane (e.g., Plane1). The remote flash plane may be the different flash plane from the flash register in which the target data is stored. In this case, the flash controller may use a router 1110 of a flash network to copy the target data stored in the flash register FR02 to an internal buffer 1111 of the router 1110 at operation S1131. Then, the flash controller may redirect the target data copied in the internal buffer 1111 to a remote flash register (e.g., FR13) so that the remote flash register FR13 store the target data at operation S1132. Once the target data is available in the remote flash register FR13, the flash controller may write the target data stored in the flash register FR13 to the remote flash plane (Plane0, i.e., a log block or data block of the remote flash plane (Plane0 at operation S1133.

According to embodiments described above, the write requests can be served by grouping the flash registers without any hardware modification on existing flash architectures.

Referring to FIG. 12, some embodiments may build a fully-connected network to make a plurality of flash registers directly connect to a plurality of flash planes and I/O ports. A plurality of flash registers (FR0, FR1, FR2, FRn−2, FRn−1, and FRn) formed in a plurality of flash planes (Plane0, Plane1, Plane2, and Plane3) included in the same flash package may be connected to the plurality of flash planes (Plane0, Plane1, Plane2, and Plane3) and I/O ports 1210 and 1220. For convenience, it is shown in FIG. 12 that two dies (Diet) and Diel) are formed in one flash package and two flash planes (Plane0 and Plane1 or Plane2 and Plane3) are formed in each die (Diet) or Diel). Even if data stored in one flash register is written to a remote flash plane through such a network, flash network bandwidth may not be consumed.

While the fully-connected network can maximize internal parallelism within the flash package, it may need a large number of point-to-point wire connections. In some embodiments, as shown in FIG. 13, the hardware can be optimized by connecting the flash registers to the I/O ports and the flash planes with a hybrid network so that hardware cost can be reduced and high performance can be achieved.

Referring to FIG. 13, all flash registers of the same flash plane may be connected to two types of buses (a shared data bus and a shared I/O bus). The shared I/O bus may be connected to an I/O port, and the shared data bus may be connected to local flash planes. A plurality of flash registers FR00 to FR0n formed in a flash plane (Plane0) may be connected to a shared data bus 1311 and a shared I/O bus 1312. A plurality of flash registers FR10 to FR1n formed in a flash plane (Plane1) may be connected to a shared data bus 1321 and a shared I/O bus 1322. A plurality of flash registers FRN0 to FRNn formed in a flash plane (PlaneN) may be connected to a shared data bus 1331 and a shared I/O bus 1332. Further, the shared data bus 1311 may be connected to the local flash plane (Plane0), the shared data bus 1321 may be connected to the local flash plane (Plane1), and the shared data bus 1331 may be connected to the local flash plane (PlaneN). Furthermore, the shared I/O buses 1312, 1322, and 1332 may be connected to an I/O port 1340.

A flash register (e.g., one flash register) from among the plurality of flash registers formed in each flash plane may be assigned as a data register. A flash register FR0n among the plurality of flash registers FR00 to FR0n formed in the plane (Plane0) may be assigned as a data register. A flash register FR1n among the plurality of flash registers FR10 to FR1n formed in the plane (Plane1) may be assigned as a data register. A flash register FRNn among the plurality of flash registers (FRN0 to FRNn) formed in the plane (PlaneN) may be assigned as a data register.

In addition, the data registers FR0n, FR1n, and FRNn, and other flash registers FR01 to FR0n−1, FR11 to FR1n−1, and FRN1 to FRNn−1) may be connected to each other through a local network 1350.

In this structure, a control logic of a flash medium may select a flash register to use the I/O port 1340 from among the plurality of flash registers. That is, target data of a memory request may be stored in the selected flash register. At the same time, the control logic may select another flash register to access the flash plane. That is, data stored in another flash registers can be written to the flash plane.

On the other hand, the flash register (e.g., FR00) may directly access the local flash plane (e.g., Plane0) through the shared data bus (e.g., 1311), but it may not directly access the remote flash plane (e.g., Plane1 or PlaneN). In this case, the control logic may first move (e.g., copy) the target data stored in the flash register FR00 to the remote data register (e.g., FR1n) of the remote flash plane (e.g., Plane1) through the local network 1350, and then write the data stored in the remote data register FR1n to the remote flash plane (Plane1) through the shared data bus 1321. In other words, the remote data register FR1n may evict the target data to the remote flash plane. As such, although the data is migrated between the two flash registers when the data is written to the remote flash plane, the data migration does not occupy flash network. In addition, since multiple data can be migrated in the local network simultaneously, excellent internal parallelism than can be achieved.

FIG. 14 shows an example of connection of flash registers included in one flash plane. Referring to FIG. 14, each of a plurality of flash registers 1410 other than a data register 1420 may include a plurality of memory cells 1411. The memory cell 1411 may be, for example, a latch. First and second transistors 1412 and 1413 for data input/output (I/O) may be connected to each memory cell 1411. The data register 1420 may also include a plurality of memory cells 1421. First and second transistors 1422 and 1423 for data I/O may be connected to each memory cell 1421.

First terminals of a plurality of first control transistors 1431 for I/O control may be connected to a shared I/O bus 1430. A second terminal of each first control transistor 1431 may be connected to, through a line 1432, first terminals of corresponding first transistors 1412 and 1422 among the first transistors 1412 and 1422 formed in the flash registers 1410 and the data register 1420. A second terminal of each first transistor 1412 or 1422 may be connected to a first terminal of the corresponding memory cell 1411 or 1421.

Second terminals of a plurality of second control transistors 1441 for data write control may be connected to a shared data bus 1440. A first terminal of each second control transistor 1441 may be connected, through a line 1442, to second terminals of corresponding second transistors 1413 and 1423 among the second transistors 1413 and 1423 formed in the flash registers 1410 and the data register 1420. A first terminal of each second transistor 1413 or 1423 may be connected to a second terminal of the corresponding memory cell 1411 or 1421.

A plurality of line 1432 connected to the first terminals of the first transistors 1412 and 1422 may be connected, through a plurality of first network transistors 1451, to a plurality of lines 1442 that are connected to second terminals of a plurality of second transistors 1413 and 1423 included in another flash plane. A plurality of line 1442 connected to the second terminals of the second transistors 1413 and 1423 may be connected, through a plurality of second network transistors 1452, to a plurality of lines 1432 that are connected to first terminals of a plurality of first transistors 1412 and 1422 included in another flash plane.

Control terminal of the transistors 1412, 1413, 1421, 1431, 1441, and 1442 may be connected to a control logic 1460.

When writing data to the flash register 1410, the control logic 1460 may turn on the first control transistor 1421 and the first transistor 1412 corresponding to the flash register 1410. Accordingly, the data transferred through the I/O shared bus 1430 may be stored, through the first control transistor 1421, in the flash register 1410 whose first transistor 1412 is turned on. When writing the data from the flash register 1410 to the flash plane, the control logic 1460 may turn on the second control transistor 1441 and the second transistor 1413 corresponding to the flash register 1410. Accordingly, the data stored in the flash register 1410 whose second transistor 1413 is turned on may be transferred, through the second control transistor 1441, to the shared data bus 1440 to be written to the flash plane.

In addition, when moving data from the flash register 1410 to a remote data register, the control logic 1460 may turn on the second transistor 1413 and the second network transistor 1452 corresponding to the flash register 1410, and turn on the first transistor 1422 and the first network transistor 1451 corresponding to the remote data register 1420. And can be turned on. Accordingly, the data stored in the flash register 1410 whose second transistor 1413 is turned on may be moved to the remote flash plane through the second network transistor 1452, and be stored to the remote data register 1420 whose first transistor 1422 is turned on through the first network transistor 1451 of the remote flash plane. Next, a remote control logic 1460 may write the data to the remote flash plane by turning on the second control transistor 1441 and the second transistor 1413 corresponding to the remote data register 1420.

As such, the control logic 1460 may select the flash register to use the shared I/O bus 1430 by turning on the transistors while it may simultaneously select another flash register to access the local flash plane. On the other hand, assigning a flash register from the group of flash registers to as data register may allow the data to be written to the remote flash plane. In other words, the control logic may first move the data to the remote data register and then write the data moved to the remote data register to the remote flash plane. As such, when the data is migrated, only the local network may be used and the flash network may not be occupied. In addition, since multiple data can be migrated in the local network simultaneously, excellent internal parallelism than can be achieved.

In some embodiments, the GPU may further include a thrashing checker to monitor whether there is cache thrashing in the limited flash registers. When the thrashing checker determines that there is the cache thrashing, a few cache space (L2 cache space) may be pinned to place excessive dirty pages.

In some embodiments, a GPU may directly attach flash controllers to a GPU interconnect network so that memory requests can be served across different flash controllers in an interleaved manner

Accordingly, a performance bottleneck occurring in the traditional GPU can be removed. In some embodiments, a GPU may connect a flash memory to a flash network instead of being connected to the GPU interconnect network so that network resources can be fully utilized. In some embodiments, a GPU may change the flash network from a bus to a mesh structure so that the bandwidth requirement of the flash memory can be met.

In some embodiments, flash address translation may split into at least two parts. First, a read-only mapping table may be integrated in an internal MMU of a GPU so that memory requests can directly get their physical addresses when the MMU looks up the mapping table to translate their virtual addresses. Second, when there is a memory write, target data and updated address mapping information may be simultaneously recorded in a flash cell array and a flash row decoder. Accordingly, computation overhead due to the address translation can be hidden.

In some embodiments, a flash memory may be directly connected to a cache through flash controllers. In some embodiments, a resistive memory can be used as a cache to buffer more pages from flash memory. In some embodiments, a GPU may use a resistance-based memory as a cache to buffer more number of pages from the flash memory. In some embodiments, a GPU may further improve space utilization of the cache by predicting spatial locality of pages fetched to the cache. In some embodiments, as the resistance-based memory suffers from long write latency, a GPU may construct the cache as a read-only cache. In some embodiments, to accommodate write requests, a GPU may flash registers of the flash memory as a write buffer (cache). In some embodiments, a GPU may configure flash registers within a same flash package as a fully-associative cache to accommodate more write requests.

While this invention has been described in connection with what is presently considered to be practical embodiments, it is to be understood that the invention is not limited to the disclosed embodiments. On the contrary, it is intended to cover various modifications and equivalent arrangements included within the spirit and scope of the appended claims.

What is claimed is:

1. A coprocessor comprising:
a processor that corresponds to a core of the coprocessor and generates a memory request;
a cache used as a buffer of the processor;
an interconnect network;
a flash network;
a flash memory; and
a flash controller that is connected to the processor and the cache through the interconnect network, is connected to the flash memory through the flash network, and reads or writes target data from or to the flash memory.

2. The coprocessor of claim 1, wherein the flash controller includes a plurality of flash controllers, and
wherein memory requests are interleaved over the flash controllers.

3. The coprocessor of claim 1, further comprising a memory management unit including a table that stores a plurality of physical addresses mapped to a plurality of addresses respectively, and is connected to the interconnect network,
wherein each of the physical addresses includes a physical log block number and a physical data block number,
wherein an address of the memory request is translated into a target physical address that is mapped to the address of the memory request among the physical addresses, and
wherein the target physical address includes a target physical log block number and a target physical data block number.

4. The coprocessor of claim 3, wherein a part of the table is buffered to a translation lookaside buffer (TLB) of the processor, and
wherein the TLB or the memory management unit translates the address of the memory request into the target physical address.

5. The coprocessor of claim 3, wherein the flash memory includes a plurality of physical log blocks, and
wherein each of the physical log blocks stores page mapping information between a page index and a physical page number.

6. The coprocessor of claim 5, wherein the address of the memory request is split into at least a logical block number and a target page index, and
wherein when the memory request is a read request and the target page index hits in the page mapping information of a target physical log block indicated by the target physical log block number, the target physical log block reads the target data based on the page mapping information.

7. The coprocessor of claim 5, wherein the address of the memory request is split into at least a logical block number and a target page index, and
wherein when the memory request is a read request and the target page index does not hit in the page mapping information of a target physical log block indicated by the target physical log block number, a physical data block indicated by the target physical data block number reads the target data based on the target page index.

8. The coprocessor of claim 5, wherein the address of the memory request is split into at least a logical block number and a target page index, and
wherein when the memory request is a write request, a target physical log block indicated by the target physical log block number writes the target data to a free page in the target physical log block, and stores mapping between the target page index and a physical page number of the free page to the page mapping information.

9. The coprocessor of claim 5, wherein each of the physical log blocks includes a row decoder, and
wherein the row decoder includes a programmable decoder for storing the page mapping information.

10. A coprocessor comprising:
a processor that corresponds to a core of the coprocessor;
a cache used as a read buffer of the processor;
a flash memory including an internal register used as a write buffer of the processor and a memory space for storing data; and
a flash controller that when a read request from the processor misses in the cache, reads read data of the read request from the flash memory, and first stores write data of a write request from the processor to the write buffer before writing the write data to the memory space of the flash memory.

11. The coprocessor of claim 10, further comprising:
an interconnect network that connects the processor, the cache, and the flash controller; and
a flash network that connects the flash memory and the flash controller.

12. The coprocessor of claim 10, further comprising a cache control logic that records an access history of a plurality of read requests, and predicts spatial locality of an access pattern of the read requests to determine a data block to be prefetched.

13. The coprocessor of claim 12, wherein the cache control logic predicts the spatial locality based on program counter addresses of the read requests.

14. The coprocessor of claim 13, wherein the cache control logic includes a predictor table including a plurality of entries indexed by program counter addresses,
wherein each of the entries includes a plurality of fields that record information on pages accessed by a plurality of warps, respectively, and a counter field that records a counter corresponding to a number of times the pages recorded in the fields are accessed, and
wherein in a case where a cache miss occurs, when the counter of an entry indexed by a program counter address of a read request corresponding to the cache miss is greater than a threshold, the cache control logic prefetches a data block corresponding to the page recorded in the entry indexed by the program counter address.

15. The coprocessor of claim 14, wherein the counter increases when an incoming read request accesses a same page as the page recorded in the fields of a corresponding entry, and decreases when an incoming read request accesses a different page from the page recorded in the fields of the corresponding entry.

16. The coprocessor of claim 12, wherein the cache control logic tracks data access status in the cache and dynamically adjusts a granularity of prefetch based on the data access status.

17. The coprocessor of claim 16, wherein the cache includes a tag array, and
wherein each of entries in the tag array includes a first bit that is set according to whether a corresponding cache line is filled by prefetch and a second bit that is set according to whether the corresponding cache line is accessed, and
wherein the cache control logic increases an evict counter when each cache line is evicted, determines whether to increase an unused counter based on values of the first and second bits corresponding to each cache line, and adjusts the granularity of prefetch based on the evict counter and the unused counter.

18. The coprocessor of claim 17, wherein when the first bit has a value indicating that the corresponding cache line is filled by prefetch and the second bit has a value indicating that the corresponding cache line is not accessed, the unused counter is increased, and
wherein the cache control logic determines a waste ratio of prefetch based on the unused counter and the evict counter, increases the granularity of prefetch when the waste ratio is higher than a first threshold, and decreases the granularity of prefetch when the waste ratio is lower than a second threshold that is lower than the first threshold.

19. The coprocessor of claim 10, wherein the flash memory includes a plurality of flash planes,
wherein the internal register includes a plurality of flash registers included in the flash planes, and
wherein a flash register group including the flash registers operates as the write buffer.

20. The coprocessor of claim 10, wherein the flash memory includes a plurality of flash planes including a first flash plane and a second flash plane,
wherein each of the flash planes includes a plurality of flash registers,
wherein at least one flash register among the flash registers included in each of flash planes is assigned as a data register,
wherein the write data is stored in a target flash register among the flash registers of the first flash plane, and
wherein when the write data stored in the target flash register is written to a data block of the second flash plane, the write data moves from the target flash register to the data register of the second flash plane, and is written from the data register of the second flash plane to the second flash plane.

21. A coprocessor comprising:
a processor that corresponds to a core of the coprocessor;
a memory management unit including a table that stores a plurality of physical addresses mapped to a plurality of addresses, respectively, each of the physical addresses including a physical log block number and a physical data block number,
a flash memory that includes a plurality of physical log blocks and a plurality of physical data blocks, wherein each of the physical log blocks stores page mapping information between page indexes and physical page numbers,
a flash controller that reads data of a read request generated by the processor from the flash memory, based on a physical log block number or target physical data block number that is mapped to an address of the read request among the physical addresses, the page mapping information of a target physical log block indicated by the physical log block number mapped to the address of the read request, and a page index split from the address of the read request.

22. The coprocessor of claim 21, wherein the flash controller writes data of a write request generated by the processor to a physical log block indicated by a physical log block number that is mapped to an address of the write request among the physical addresses.

23. The coprocessor of claim 22, wherein mapping between a physical page number indicating a page of the physical log block to which the data of the write request is written and a page index split from the address of the write request is stored in the page mapping information of the physical log block indicated by the physical log block number mapped to the address of the write request.
